(19) United States
(12) Patent Application Publication
(10) Pub. No.: US 2024/0256998 A1
(43) Pub. Date: Aug. 1, 2024

(54) MODEL-BASED CANDIDATE SCREENING AND EVALUATION TOOLS

(71) Applicant: The Toronto-Dominion Bank, Toronto (CA)

(72) Inventor: Moshe Karl, Petah Tikva (IL)

(21) Appl. No.: 18/162,053

(22) Filed: Jan. 31, 2023

(51) Int. Cl. G06Q 10/0631; G06Q 10/1053

(52) U.S. Cl. CPC G06Q 10/063112; G06Q 10/1053

(57) ABSTRACT

One example method includes identifying, using a text analysis engine, one or more job description skills from a job description. One or more job description rankings can be generated, each job description ranking corresponding to a respective job description skill. One or more candidate skills can be identified, using the text analysis engine, from a curriculum vitae (CV) of a candidate. One or more candidate skill rankings can be generated, each candidate skill ranking corresponding to a respective candidate skill. One or more distances can be computed based on the one or more job description rankings and the one or more candidate skill rankings. The one or more distances can be dynamically updated based on real-time updates to the one or more candidate skill rankings during a communication with the candidate.

### TECHNICAL FIELD

The present disclosure generally relates to data processing techniques and provide computer-implemented methods, software, and systems for automating identifications of disparities between job requirements and candidate's stated skills, automating candidate impression extraction based on interview notes analysis, and recommending actions to be performed with respect to the candidates.

### BACKGROUND

Employee hiring and screening processes can be highly manual and require significant amount of time and computing resources. A typical hiring process involves interviews of job candidates and activities before, during, and after the interviews. Before the interviews, an employer can distribute to the public a job description summarizing the responsibilities, activities, qualifications, and skills for a job opening. A job applicant can submit their curriculum vitae (CV, also referred to as resume) to the employer, sometimes in response to the distributed job description.

One or more employees of the employer can be assigned to screen job applicants. The employee(s) may evaluate job applicants' CVs and perform an initial screening that typically includes determining, for example, whether to grant an interview to a job applicant, the interviewers to interview the job applicant, the interview time allocated to the job applicant, etc. Then, for a candidate who passes the screening, an interviewer can review the candidate's CV and plan a list of questions to ask the candidate during the interview.

During the interview, the interviewer may discuss and evaluate the candidate's skillset, as may be articulated in the candidate's CV. The interviewer typically takes notes to record the candidate's responses and/or the impressions of the interviewer on the candidate, which may be used in the decision making regarding whether to hire the candidate.

As will be appreciated, there is rarely any structure to the impressions captured by an interviewer in textual form. Indeed, a large amount of unstructured data (or data with varying structure) can be collected during the interview process—from pre-screening, to CV review, to notes capturing impressions and thoughts of an interviewer—given that there is no standard form of CVs and notes collections for such processes. As such, analytics or objective data analysis is generally not feasible on such data, which in turn makes the interview process less resource efficient and more prone to error because decisions are more likely to be made on subjective determinations that are not necessarily grounded on objective factual data learned prior to and during the interview process.

### SUMMARY

The present disclosure generally relates to systems, software, and computer-implemented methods for automating identifications of disparities between job requirements and candidate's stated skills, automating candidate impression extraction based on interview notes analysis, and recommending actions to be performed on the candidates.

A first example method includes identifying, using a text analysis engine, one or more job description skills from a job description. One or more job description rankings can be generated, each job description ranking corresponding to a respective job description skill. One or more candidate skills can be identified, using the text analysis engine, from a curriculum vitae (CV) of a candidate. One or more candidate skill rankings can be generated, each candidate skill ranking corresponding to a respective candidate skill. One or more distances can be computed based on the one or more job description rankings and the one or more candidate skill rankings. The one or more distances can be dynamically updated based on real-time updates to the one or more candidate skill rankings during a communication with the candidate.

Implementations can optionally include one or more of the following features.

In some implementations, generating the one or more job description rankings includes: identifying one or more words comprised in the job description associated with description of a job description skill; determining whether the one or more words correspond to a job description ranking; and in response to determining that the one or more words correspond to a job description ranking, assigning the job description ranking to the job description skill.

In some implementations, the one or more candidate skill rankings are generated based on at least one of: a number of times a candidate skill is comprised in the CV; a number of jobs in the CV comprising the candidate skill; or a font used to encode a candidate skill in the CV.

In some implementations, computing the one or more distances based on the one or more job description rankings and the one or more candidate skill rankings includes: in response to determining that none of the one or more candidate skills corresponds to a job description skill, setting a distance associated with the job description skill to a predetermined maximum value; in response to determining that a candidate skill ranking of a candidate skill is higher than or equal to a job description ranking of a job description skill, setting a distance between the candidate skill and the job description skill to a predetermined minimum value; or in response to determining that a candidate skill ranking of a candidate skill is lower than a job description ranking of a job description skill, setting a distance between the candidate skill and the job description skill to a difference between the job description ranking and the candidate skill ranking.

In some implementations, the first example method includes generating an aggregate score based on the one or more distances.

In some implementations, the aggregate score is used to determine at least one of: whether to perform the communication with the candidate; a duration of the communication with the candidate; or a hiring decision of the candidate.

In some implementations, dynamically updating the one or more distances based on the real-time updates to the one or more candidate skill rankings during the communication with the candidate includes: obtaining digitized text representing notes of the communication with the candidate; analyzing the digitized text to generate one or more impression results corresponding to a candidate skill; and updating, based on the one or more impression results, a distance corresponding to the candidate skill.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, in some implementations, the techniques described herein can be used to enable data analysis on unstructured text by imposing structural constraints on the text, which allows for candidate skill evaluation regardless of the form and structure of the source of the text (i.e., the CV and the job description). For example, the techniques can identify a skill included in the unstructured text (e.g., based on text analysis and/or machine learning model) and analyze the context of the skill to generate a ranking of the skill. Compared to current skill extraction methods that largely extract skill descriptions from structured text, the techniques can be widely applicable to any type of unstructured text and allow operation within existing systems (without any need to rework processes or require any particular configuration).

In some cases, the techniques described herein allow real-time skill updates that result in more accurate candidate selection or pre-screening. In some embodiments, the techniques described herein allow obtaining, during or after the interview, digitized text (which can simply be text typed by an interviewer or digitized version of handwritten or oral notes) representing interview notes about a candidate. The digitized text can be analyzed to generate one or more impression results corresponding to a candidate skill (e.g., an impression score representing the interviewer's assessment of the proficiency of the candidate skill). The one or more impression results can then be used by the system to dynamically update a distance between the candidate skill and the job requirements. This allows to refine the initial assessments of disparities between job requirements and candidate's stated skills, and thus results in more accurate candidate selection or pre-screening.

In some examples, the techniques described herein consume fewer computing resources because of limited additional analysis that would otherwise be required from storing and interpretation of free-form/unstructured text. For example, in some embodiments, the techniques described herein enable establishment of mapping relationships (e.g., a database, a data table, etc.) between CV skills and job description skills, which in turn allow for approximate matchings (e.g., fuzzy keyword searches) in searching for a CV skill corresponding to a job description skill. This allows quickly matching job description skills and CV skills, and dynamically learning new mappings (e.g., using a machine-learning model that is trained to infer mappings based training of the model using a set of such mappings), without consuming large quantity of computing resources and also result in greater accuracy stemming from improved matching compared to current solutions that use a series of rigid and inflexible rules that generally need constant changing.

In some implementations, the techniques described herein can implement a feedback-based model that can enable more accurate skills matching as informed by real-time user updates. For example, in some cases, a machine learning model can initially compute a set of distances between the candidate skills and the job requirements. The set of distances can be automatically updated based on the candidate's performance in the interview and based on any notes and feedback provided by the interviewer during the interview. The updated differences can then be used to fine-tune the machine learning model (e.g., tune the weights of various features of the model), which in turn can continue to evolve and dynamically improve its matching algorithms, which then enables more accurate skills matching.

In some cases, unlike the conventional sentiment analysis methods that ignore or do not add any weight to the landmarks that are key sentiment indicators in the interview notes, the solution described herein enables more accurate impression extraction by using landmarks and their context to compute the impression result(s). This in turn can enable more accurate identification of a reviewer's subjective intent than may be offered or available via the literal text of their notes.

In some implementations, the solution herein can increase the efficiencies of analyzing interview notes for candidate selection processes. Unlike conventional solutions, the solution described herein can deploy sentiment analysis tools with proper weighting for the specific context of interviews, to facilitate a more objective analysis of a reviewer's impressions toward a candidate. Indeed, and to this end, the techniques described herein enable more accurate analysis of unstructured text that can be used for more accurate candidate selection/screening. For example, in some cases, the techniques can identify landmarks in the unstructured text and generate one or more impression scores based on the landmarks and the surrounding context in which they appear. Compared to other conventional text analysis solutions, the techniques described herein can generate more accurate sentiment results by adding weights to the landmarks that are key sentiment indicators in unstructured text and then determining the overall impressions of the interviewer on particular topics and/or as a whole-all without requiring the interviewer to provide such notes.

In some implementations, a feedback-based model can be implemented, which facilitates more accurate skills matching as informed by sentiment analysis of the unstructured notes-which in turn results in more accurate skills assessment matching over time. For example, in some cases, the techniques described herein allow obtaining, during or after the interview, digitized text representing interview notes with a candidate. The digitized text can be analyzed to generate one or more impression results corresponding to a candidate skill (e.g., an impression score representing the interviewer's assessment of the proficiency of the candidate skill). The one or more impression results can then be used to dynamically update a distance between the candidate skill and the job requirements. The updated distance can be input into the feedback-based model that generated the initial assessments of distances between job requirements and candidate's stated skills. Therefore, the feedback-based model can be refined based on the updated distance, and can provide more accurate skills assessment matching overtime. In this manner, the techniques described herein implement a dynamic, model-based approach that allows for greater accuracy and standardization to an area of text analysis that is otherwise highly variable and unstructured.

In some cases, the techniques described herein are not limited to digital text analysis, but could be performed on virtually any input (e.g., handwritten text, oral notes, etc.). In some cases, the techniques described herein can digitize the input by, for example, performing text recognition on handwritten text or performing audio recognition to generate a transcript for an audio. By expanding the input types, the techniques described herein have wider applicability than conventional methods that only take digital text as input.

In summary, unlike current techniques, the techniques described herein enable deployment of a dynamic model-based solution that achieves greater accuracy and consistency (from applying a standard rubric for job applicants that is not reviewer/screener dependent) and improved resource efficiencies in candidate screening and selection relative to conventional techniques implemented for these tasks.

### DESCRIPTION OF DRAWINGS

FIG. 1 is a block diagram of an example networked environment for automating interview process and candidate ranking in a networked environment.

FIG. 2 illustrates a data and control flow of example interactions performed for automating identifications of disparities between job requirements and candidate's stated skills, and dynamically updating the disparities based on a communication with the candidate.

FIG. 3 is a flow diagram of an example method for automating identifications of disparities between job requirements and candidate's stated skills.

FIG. 4 illustrates a data and control flow of example interactions performed for automating candidate impression extraction based on interview notes analysis.

FIG. 5 is a flow diagram of an example method for automating candidate impression extraction based on interview notes analysis.

### DETAILED DESCRIPTION

The present disclosure generally relates to various tools and techniques associated with automating identifications of disparities between job requirements and candidate's stated skills, automating candidate impression extraction based on interview notes analysis, and recommending actions to be performed on the candidates.

As noted, various technical problems can arise during job screening and hiring processes. An example technical problem includes inefficient (and often incorrect) identification of disparities between job requirements and candidate's stated skills. An employer can receive a large quantity of curriculum vitas (CVs) for a job opening, sometimes in the scales of hundreds or even thousands. Manually screening these CVs to eliminate the job applicants and identify those to grant the interviews can be very time-consuming. And even when computing resources are deployed, such processes can be highly resource intensive. Further still, even when computing solutions are deployed to the task of identifying disparities, those solutions operate mostly on structured data (i.e., text having a predefined organization or labeling/categorizing) and are unable to accurately perform disparity analysis when confronted with unstructured (or widely varying) text which does not have a predefined organization or labeling/categorizing (in the form of different and distinct job description/resume formats and types).

Further, interviews are time-limited and typically provide time to cover a limited number of focus areas/topics. One particular key focus area frequently examined and validated during interviews is the candidate's stated skills that are required in the job description. However, it is inefficient (e.g., time and resource intensive) for the interviewer to identify the candidate's relevant skills from the free-text of the CVs.

Some conventional skill extraction methods attempt to automate the extractions of candidates' skills from the CV and/or automate the extractions of required skills from a job description. The conventional skill extraction methods typically use a text engine to analyze text and extract an unprioritized list of skills from a CV and/or a job description. The unprioritized list of skills can then be provided to a person to perform further manual review and determine the fitness of the candidate for the job opening.

However, such conventional skill extraction methods suffer from multiple deficiencies. As an initial matter, these conventional methods generally identify an unprioritized list of skills described in the CV, but do not rank these skills based on the candidate's skill levels for these skills (e.g., from a proficient skill to a beginner-level skill). Similarly, these conventional methods identify an unprioritized list of required skills described in the job description without ranking these skills from a must-have skill to a less critical skill. As a result, matching the required skills to the skills articulated in the CV—both of which are described textually in highly varying forms—is generally a highly resource intensive task and relies on arbitrary rules that fail to efficiently do such skill matching and prioritization (generally because such rules are unable to account for the different possible variations in text specification of required and included skills). This lowers the efficiencies of the screening and interview processes, putting further burden on the initial screening tools that are used to pre-screen candidates as well as on the interviewer who is time constrained, but yet has to try to gain an understanding of the candidate's skill levels relative to the desired skillset articulated in the job description. Also, given the high volume of highly unstructured data encountered by screening tools, matching and prioritizations of required skills to actual skills in a fast-paced environment (where job screening decisions have to be made within days to avoid losing good candidates) is a task that cannot be reasonably performed by humans and nor do conventional pre-screening tools have enough bandwidth and processing power to do rote analysis of all this data (and even if they did, the resulting output would require further analysis and refinement, which again would require an additional human element).

In contrast, the techniques described herein enable to identify disparities between job requirements and candidate's stated skills based on automatic text analysis and/or feedback-based model(s). At a high level, this solution automatically extracts a list of skills stated in a job description and assigns a ranking to each skill indicating the relevancy of the skill to the job opening based on automatic text analysis. Then, the solution can automatically extract a list of skills stated in a CV and assign a ranking to each skill indicating the candidate's proficiency in the skill based on automatic text analysis. The solution can then identify disparities between the job requirements and candidate's stated skills by, for example, computing differences (“distances” as described below) between rankings of the job description skills and rankings of the CV skills. The differences can be computed using a trained machine-learning model. During the interview, the differences can be dynamically adjusted in real time and the updated differences can be used to fine-tune the machine-learning model. The computed differences can also be used to guide the interview process of the candidate. Additional details of the algorithm are described below.

Another example technical problem is associated with inefficient analysis of interview notes. During the interview, an interviewer typically captures some notes that may include some or all of the candidate's responses, the impressions of the interviewer on the candidate, etc. Sometimes, the impressions can be embedded in unstructured free-text notes without being explicitly stated. One way to implicitly represent the interviewer's impressions is by using landmarks (e.g., capital/bold/underlined words, emoticons, punctuation marks, etc.). As personal impressions fade over time, the captured free-text notes become a good source for recollecting said impressions to support candidates' ranking, profiling, and/or selection/fit decision. Because of large variances between different positions and candidates, there's no universal template that can be filled post-interview to capture relevant impressions in a consistent manner. Therefore, an interviewer or decision maker can spend a long time reviewing the free-text notes to recall his/her impressions, sometimes having to dig into the contexts of particular landmarks. Further, when the free-text notes are shared with another person, the other person may also have to spend a long time to discern the impressions or intent of the interviewer.

While some conventional sentiment analysis methods, which typically rely on natural language processing, text analysis, computational linguistics, and biometrics to identify, extract, quantify, and study affective states and subjective information, can analyze the sentiment of a subject from unstructured free text, the conventional sentiment analysis methods suffer multiple deficiencies for interview note analysis. As an initial matter, the interview notes are typically very rough and highly variable (depending on the interviewer), particularly given the time constraints under which interviews are conducted and notes regarding the same are collected. As a result, landmarks are frequently used in interview notes as shorthand to express the impressions. The conventional sentiment analysis methods typically input the entire text to generate a sentiment result, but do not assign particular weights to landmarks—an important characteristic of interview notes in generating their analysis results. Therefore, the conventional methods can often generate incorrect impressions when analyzing interview notes. Further, the conventional sentiment analysis methods can—at most—identify sentiments and highlight text segments contributing to the sentiments, which nevertheless still require manual processes to analyze the highlighted text to identify the topics or subjects (e.g., one or more keywords describing the discussion topics) that led to the sentiment, particularly in the context of interviews and job recommendations.

In contrast, in some cases, the techniques described herein refine the sentiment analysis methods by, for example, factoring the landmarks included in the notes in the computation, to provide a more accurate assessment of the interviewee than what could be provided by conventional sentiment analysis methods. At a high level, this solution performs text analysis to transcribe and process written interview notes (or perhaps even oral notes captured in an audio), giving particular weights to the landmarks included in the notes in the computation, and generating one or more results representing impressions toward the candidate (e.g., an overall impression score toward the candidate, the subjects contributing to the landmarks, etc.). More specifically, the solution starts by identifying and highlighting a landmark in an interview note. A landmark can be any characteristic present in text that indicates a writer's sentiment or feeling to the subject matter being described. For example, a landmark can be one or more words that are capitalized, bolded, and/or underlined, one or more emoticons, one or more punctuation marks (e.g., exclamation marks), etc. The context of the landmark (e.g., words in the vicinity of the landmark, e.g., within 2-3 lines above and below the identified landmark) can then be analyzed by text analysis engines to generate the one or more impression results relating to the determined context.

The techniques described herein can be used in the context of interview process and candidate ranking, in particular, identifications of disparities between job requirements and candidate's stated skills and candidate impression extraction based on interview notes analysis. These use cases can be applied to any organization that interviews candidates, including but not limited to companies, corporations, governments, non-governmental organizations, political organizations, international organizations, armed forces, charities, not-for-profit corporations, partnerships, cooperatives, and educational institutions, etc. One skilled in the art will appreciate that the techniques described herein are not limited to just these applications but can be applicable in other contexts.

For example, in some implementations, the techniques described herein for automatically extracting impressions of the creator of the digital text can be extended to other use cases for extracting impressions from any digital text that includes landmarks. Example of such use cases include but not limited to analyzing a customer's impressions toward a merchant based on chat history, analyzing a reviewer's impressions toward a reviewee based on the reviewer's report, extracting a person's impressions toward a subject from emails, etc.

In one example use case, the techniques described herein can be used to analyze the text generated by a customer on a product (e.g., reviews written by the customer on the product, chat history of the customer on the product, etc.) to evaluate the customer's impressions toward the product (e.g., beyond stars or numerical rating that a customer may provide, which can be highly variable between customers). In another example use case, an employer can use the techniques described herein for performance management evaluations for existing employees. For example, the review report(s) of a reviewer for an existing employee can be analyzed to generate impressions of the reviewer toward the existing employee.

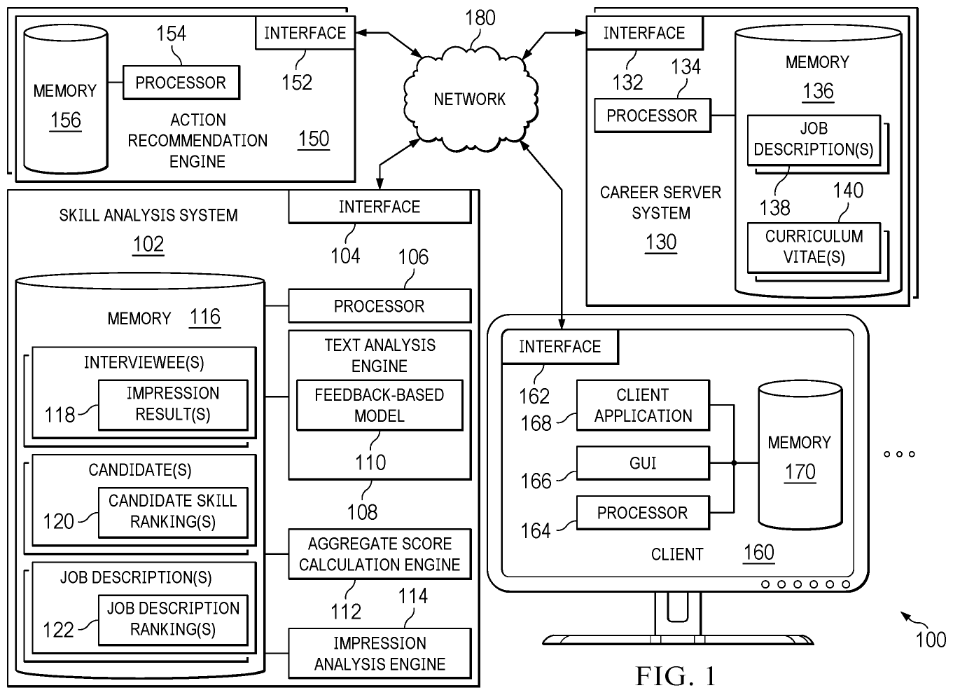

Turning to the illustrated example implementation, FIG. 1 is a block diagram of an example networked environment 100 for automating interview process and candidate ranking in a networked environment. As further described with reference to FIG. 1, the environment implements various systems that interoperate to automate identifications of disparities between job requirements and candidate's stated skills, automate candidate impression extraction based on interview notes analysis, and subsequently recommend action(s) to the candidates (e.g., granting interviews, prioritizing interview questions, making job offers, etc.).

As shown in FIG. 1, the example environment 100 includes a skill analysis system 102, a career server system 130, an action recommendation engine 150, and multiple clients 160 that are interconnected over a network 180. The function and operation of each of these components is described below.

In some implementations, the illustrated implementation is directed to a solution where the career server system 130 can receive job descriptions and CVs from, for example, career website portals, client devices, other servers, etc., and store the received job descriptions and CVs. The career server system 130 can then transmit the job descriptions and CVs to the skill analysis system 102 periodically (e.g., every 30 days, every 7 days, etc.). In some instances, the career server system 130 can transmit the job descriptions and/or CVs to the skill analysis system 102, upon the detection of a particular event (e.g., a job description or a CV is newly submitted or updated). In some cases, the career server system 130 can transmit job description(s) and CV(s) to the text analysis engine 108.

After obtaining a job description from the career server system 130, the text analysis engine 108 can apply text analysis and recognition algorithms to parse the job description and extract therefrom the job description skills required and/or preferred for the job opening, and then generate the corresponding job description rankings. In addition, after obtaining a CV from the career server system 130, the text analysis engine 108 can parse the CV to extract the candidate skills described in the CV and generate the corresponding candidate skill rankings. After determining the job description rankings and the candidate skill rankings, the text analysis engine 108 can compute distances between the job description rankings and the candidate skill rankings (e.g., using the feedback-based model 110).

In some cases, the text analysis engine 108 can transmit the computed distances between the job description rankings and the candidate skill rankings to the aggregate score calculation engine 112, which can then generate an aggregate score for each candidate based on the computed distances. In some examples, the aggregate score calculation engine 112 can sum up the computed distances of a candidate to generate an aggregate score for the candidate. In general, the aggregate score is directly correlated with the candidate's fitness to the job opening. So, for example, a high aggregate score indicates a large disparity between the candidate's stated skills and the skills to perform the job, whereas a low aggregate score indicates a high likelihood that the candidate's skills satisfy the job requirements.

In some cases, the aggregate score calculation engine 112 can transmit the generated aggregate score(s) to the action recommendation engine 150, which can then recommend one or more actions for a candidate based on the candidate's aggregate score and/or the computed distances of the candidate. In some examples, the action recommendation engine 150 can transmit the action recommendation(s) to the client 160, which can then display the action recommendation(s).

In some cases, the candidate skill ranking and/or a distance corresponding to the candidate skill can be updated (e.g., based on impression result(s) generated from automatic analysis of the interview notes). After a candidate skill ranking and/or a distance corresponding to the candidate skill is updated, the updated candidate skill ranking and/or distance can be provided as input/feedback to the feedback-based model 110, which generated the initial candidate skill ranking and/or the distance, to further refine the model and improve its inference capabilities based on the human/machine annotated sample in the form of actual skill rankings.

In some implementations, the client 160 can transmit the digitized text representing the interview notes to the impression analysis engine 114. The impression analysis engine 114 can generate one or more impression results based on one or more landmarks in the digitized text. The impression analysis engine 114 can transmit the one or more impression results to the action recommendation engine 150, which can recommend one or more actions for a candidate based on the candidate's impression result(s).

As described above, and in general, the environment 100 enables the illustrated components to share and communicate information across devices and systems (e.g., the skill analysis system 102, the career server system 130, the action recommendation engine 150, the client 160, among others) via network 180. As described herein, the skill analysis system 102, the career server system 130, the action recommendation engine 150, and/or the client 160 can be cloud-based components or systems (e.g., partially or fully), while in other instances, non-cloud-based systems can be used. In some instances, non-cloud-based systems, such as on-premises systems, client-server applications, and applications running on one or more client devices, as well as combinations thereof, can use or adapt the processes described herein. Although components are shown individually, in some implementations, functionality of two or more components, systems, or servers can be provided by a single component, system, or server. Conversely, functionality that is shown or described as being performed by one component, can be performed and/or provided by two or more components, systems, or servers.

As used in the present disclosure, the term “computer” is intended to encompass any suitable processing device. For example, the skill analysis system 102, the career server system 130, the action recommendation engine 150, and/or the client 160 can be any computer or processing devices such as, for example, a blade server, general-purpose personal computer (PC), Mac®, workstation, UNIX-based workstation, or any other suitable device. Moreover, although FIG. 1 illustrates a single skill analysis system 102, a single career server system 130, a single action recommendation engine 150, and a single client 160, any one of the skill analysis system 102, the career server system 130, the action recommendation engine 150, and/or the client 160 can be implemented using a single system or more than those illustrated, as well as computers other than servers, including a server pool. In other words, the present disclosure contemplates computers other than general-purpose computers, as well as computers without conventional operating systems.

Similarly, the client 160 can be any system that can request data and/or interact with the skill analysis system 102, the career server system 130, and/or the action recommendation engine 150. The client 160, also referred to as client device 160, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client 160 can include one or more merchant- or financial institution-specific applications executing on the client 160, or the client 160 can include one or more web browsers or web applications that can interact with particular applications executing remotely from the client 160, such as applications on the skill analysis system 102, the career server system 130, and/or the action recommendation engine 150, among others.

As illustrated, the skill analysis system 102 includes or is associated with interface 104, processor(s) 106, text analysis engine 108, aggregate score calculation engine 112, impression analysis engine 114, and memory 116. While illustrated as provided by or included in the skill analysis system 102, parts of the illustrated components/functionality of the skill analysis system 102 can be separate or remote from the skill analysis system 102, or the skill analysis system 102 can itself be distributed across the network 180.

The interface 104 of the skill analysis system 102 is used by the skill analysis system 102 for communicating with other systems in a distributed environment—including within the environment 100—connected to the network 180, e.g., the career server system 130, the action recommendation engine 150, the client 160, and other systems communicably coupled to the illustrated skill analysis system 102 and/or network 180. Generally, the interface 104 comprises logic encoded in software and/or hardware in a suitable combination and operable to communicate with the network 180 and other components. More specifically, the interface 104 can comprise software supporting one or more communication protocols associated with communications such that the network 180 and/or interface's hardware is operable to communicate physical signals within and outside of the illustrated environment 100. Still further, the interface 104 can allow the skill analysis system 102 to communicate with the career server system 130, the action recommendation engine 150, the client 160, and/or other portions illustrated within the skill analysis system 102 to perform the operations described herein.

The skill analysis system 102, as illustrated, includes one or more processors 106. Although illustrated as a single processor 106 in FIG. 1, multiple processors can be used according to particular needs, desires, or particular implementations of the environment 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the skill analysis system 102. Specifically, the processor 106 executes the algorithms and operations described in the illustrated figures, as well as the various software modules and functionality, including the functionality for sending communications to and receiving transmissions from the career server system 130, the action recommendation engine 150, and/or the client 160, as well as to other devices and systems. Each processor 106 can have a single or multiple cores, with each core available to host and execute an individual processing thread. Further, the number of, types of, and particular processors 106 used to execute the operations described herein can be dynamically determined based on a number of requests, interactions, and operations associated with the skill analysis system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

The skill analysis system 102 can include, among other components, one or more applications, entities, programs, agents, or other software or similar components configured to perform the operations described herein. As illustrated, the skill analysis system 102 includes or is associated with a text analysis engine 108. The text analysis engine 108 can be any application, program, other component, or combination thereof that, when executed by the processor 106, enables automatic analysis of job descriptions and CVs. As illustrated, the text analysis engine 108 can include a feedback-based model 110, which can include or specify programmable instructions for computing distances between job requirements and candidate's stated skills.

The skill analysis system 102 can include or be associated with an aggregate score calculation engine 112. The aggregate score calculation engine 112 can be any application, program, other component, or combination thereof that, when executed by the processor 106, enables generation of aggregate scores for candidates based on the computed distances.

The skill analysis system 102 can include or be associated with an impression analysis engine 114. The impression analysis engine 114 can be any application, program, other component, or combination thereof that, when executed by the processor 106, enables generation of impression results corresponding to candidate skills based on analyzing interview notes.

As illustrated, the skill analysis system 102 can also include memory 116, which can represent a single memory or multiple memories. The memory 116 can include any memory or database module and can take the form of volatile or non-volatile memory including, without limitation, magnetic media, optical media, random access memory (RAM), read-only memory (ROM), removable media, or any other suitable local or remote memory component. The memory 116 can store various objects or data associated with the skill analysis system 102, including any parameters, variables, algorithms, instructions, rules, constraints, or references thereto. While illustrated within the skill analysis system 102, memory 116 or any portion thereof, including some or all of the particular illustrated components, can be located remote from the skill analysis system 102 in some instances, including as a cloud application or repository, or as a separate cloud application or repository when the skill analysis system 102 itself is a cloud-based system. As illustrated, memory 116 stores data associated with interviewee(s), candidate(s), and job description(s). The data associated with interviewee(s) can include impression result(s) 118 indicating impression(s) of the interviewer(s) toward interviewee(s). The data associated with candidate(s) can include candidate skill ranking(s) 120 indicating the candidate(s)′ experience level of candidate skill(s). The data associated with job description(s) can include job description ranking(s) 122 indicating the employer's determined weight (from the free-form job description) on the skill(s) they want in candidate(s).

Network 180 facilitates wireless or wireline communications between the components of the environment 100 (e.g., between the skill analysis system 102, the career server system 130, the action recommendation engine 150, the client 160, etc.), as well as with any other local or remote computers, such as additional mobile devices, clients, servers, or other devices communicably coupled to network 180, including those not illustrated in FIG. 1. In the illustrated environment, the network 180 is depicted as a single network, but can be comprised of more than one network without departing from the scope of this disclosure, so long as at least a portion of the network 180 can facilitate communications between senders and recipients. In some instances, one or more of the illustrated components (e.g., the skill analysis system 102, the career server system 130, the action recommendation engine 150, and/or the client 160, etc.) can be included within or deployed to network 180 or a portion thereof as one or more cloud-based services or operations. The network 180 can be all or a portion of an enterprise or secured network, while in another instance, at least a portion of the network 180 can represent a connection to the Internet. In some instances, a portion of the network 180 can be a virtual private network (VPN). Further, all or a portion of the network 180 can comprise either a wireline or wireless link. Example wireless links can include 802.11a/b/g/n/ac, 802.20, WiMax, LTE, and/or any other appropriate wireless link. In other words, the network 180 encompasses any internal or external network, networks, sub-network, or combination thereof operable to facilitate communications between various computing components inside and outside the illustrated environment 100. The network 180 can communicate, for example, Internet Protocol (IP) packets, Frame Relay frames, Asynchronous Transfer Mode (ATM) cells, voice, video, data, and other suitable information between network addresses. The network 180 can also include one or more local area networks (LANs), radio access networks (RANs), metropolitan area networks (MANs), wide area networks (WANs), all or a portion of the Internet, and/or any other communication system or systems at one or more locations.

As noted, the career server system 130 can receive job descriptions and CVs and transmit, to the skill analysis system 102, the job descriptions and CVs. As illustrated, the career server system 130 includes various components, including interface 132 for communication (which can be operationally and/or structurally similar to interface 104), at least one processor 134 (which can be operationally and/or structurally similar to processor(s) 106, and which can execute the functionality of the career server system 130), and at least one memory 136 (which can be operationally and/or structurally similar to memory 116). The memory 136 can store job description(s) 138 and CV(s) 140.

As noted, the action recommendation engine 150 can recommend one or more actions for a candidate based on, for example, the candidate's aggregate score and/or the computed distances of the candidate, the candidate's impression result(s), etc. As illustrated, the action recommendation engine 150 includes various components, including interface 152 for communication (which can be operationally and/or structurally similar to interface 104), at least one processor 154 (which can be operationally and/or structurally similar to processor(s) 106, and which can execute the functionality of the action recommendation engine 150), and at least one memory 156 (which can be operationally and/or structurally similar to memory 116).

As illustrated, one or more clients 160 can be present in the example environment 100. Although FIG. 1 illustrates a single client 160, multiple clients can be deployed and in use according to the particular needs, desires, or particular implementations of the environment 100. Each client 160 can be associated with a particular user (e.g., an interviewer of a job candidate), or can be associated with/accessed by multiple users, where a particular user is associated with a current session or interaction at the client 160. Client 160 can be a client device at which the user is linked or associated. As illustrated, the client 160 can include an interface 162 for communication (which can be operationally and/or structurally similar to interface 104), at least one processor 164 (which can be operationally and/or structurally similar to processor 106), a graphical user interface (GUI) 166, a client application 168, and a memory 170 (similar to or different from memory 116) storing information associated with the client 160.

The illustrated client 160 is intended to encompass any computing device, such as a desktop computer, laptop/notebook computer, mobile device, smartphone, personal data assistant (PDA), tablet computing device, one or more processors within these devices, or any other suitable processing device. In general, the client 160 and its components can be adapted to execute any operating system. In some instances, the client 160 can be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the client 160. Such information can include digital data, visual information, or a GUI 166, as shown with respect to the client 160. Specifically, the client 160 can be any computing device operable to communicate with the skill analysis system 102, the career server system 130, the action recommendation engine 150, other client(s), and/or other components via network 180, as well as with the network 180 itself, using a wireline or wireless connection. In general, the client 160 comprises an electronic computer device operable to receive, transmit, process, and store any appropriate data associated with the environment 100 of FIG. 1.

The client application 168 executing on the client 160 can include any suitable application, program, mobile app, or other component. Client application 168 can interact with the skill analysis system 102, the career server system 130, the action recommendation engine 150, other client(s), or portions thereof, via network 180. In some instances, the client application 168 can be a web browser, where the functionality of the client application 168 can be realized using a web application or website that the user can access and interact with via the client application 168. In other instances, the client application 168 can be a remote agent, component, or client-side version of the skill analysis system 102, or a dedicated application associated with the skill analysis system 102. In some instances, the client application 168 can interact directly or indirectly (e.g., via a proxy server or device) with the skill analysis system 102 or portions thereof. The client application 168 can be used to view, interact with, or otherwise transact data exchanges with the skill analysis system 102, and to allow interactions for job candidate action recommendations via the career server system 130 and the action recommendation engine 150.

GUI 166 of the client 160 interfaces with at least a portion of the environment 100 for any suitable purpose, including generating a visual representation of any particular client application 168 and/or the content associated with any components of the skill analysis system 102, the career server system 130, the action recommendation engine 150, and/or other client(s) 160. For example, the GUI 166 can be used to present screens and information associated with the skill analysis system 102 (e.g., one or more interfaces identifying computed job description rankings, candidate skill rankings, and/or distances of candidates) and interactions associated therewith, as well as presentations associated with the career server system 130 (e.g., one or more interfaces for submitting, downloading, or updating job descriptions and CVs), and/or action recommendation-related presentations associated with the action recommendation engine 150 (e.g., one or more interfaces displaying action recommendations for candidates). GUI 166 can also be used to view and interact with various web pages, applications, and web services located local or external to the client 160. Generally, the GUI 166 provides the user with an efficient and user-friendly presentation of data provided by or communicated within the system. The GUI 166 can comprise a plurality of customizable frames or views having interactive fields, pull-down lists, and buttons operated by the user. In general, the GUI 166 is often configurable, supports a combination of tables and graphs (bar, line, pie, status dials, etc.), and is able to build real-time portals, application windows, and presentations. Therefore, the GUI 166 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

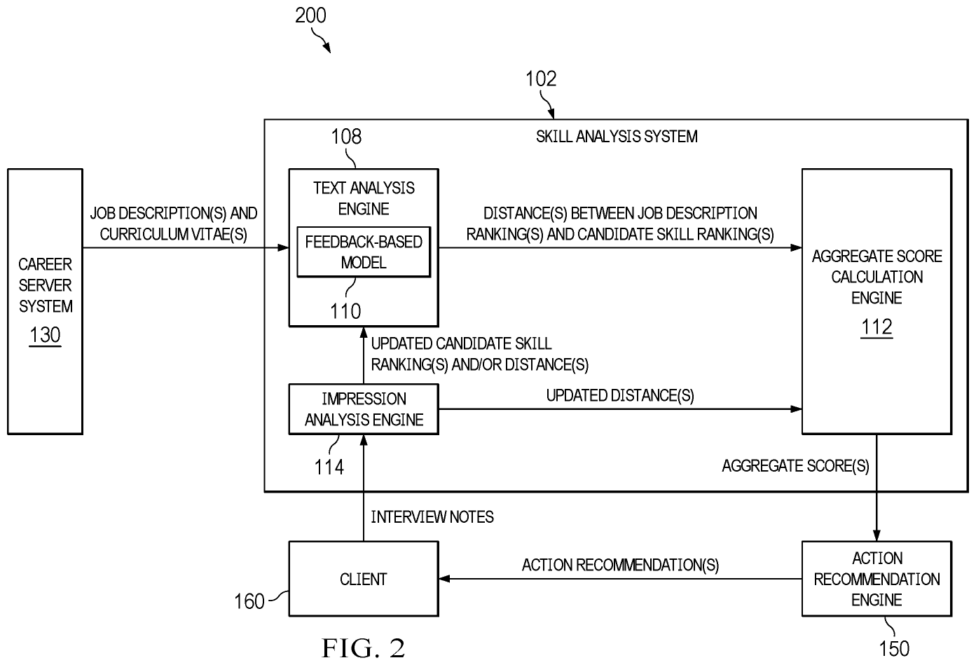

FIG. 2 illustrates a data and control flow of example interactions 200 performed for automating identifications of disparities between job requirements and candidate's stated skills, and dynamically updating the disparities based on a communication with the candidate. As explained further below, this flow diagram describes computing distances between rankings of the job description skills and rankings of the candidate skills based on automatic text analysis, and subsequently validating or updating the candidate skill ranking(s) and/or distance(s) based on the candidate's performance in the interview. As illustrated, FIG. 2 shows interactions between the career server system 130, the skill analysis system 102, the text analysis engine 108, the feedback-based model 110, the aggregate score calculation engine 112, the impression analysis engine 114, the action recommendation engine 150, and the client 160.

As illustrated in FIG. 2, the career server system 130 can transmit job description(s) and CV(s) to the text analysis engine 108. In some instances, the career server system 130 can receive CV(s) from, for example, career website portals, client devices, other servers, etc., and store the received CV(s). The career server system 130 can then transmit the CV(s) to the skill analysis system 102 periodically (e.g., every 30 days, every 7 days, etc.). In some instances, the career server system 130 can transmit the job description(s) and/or the CV(s) to the skill analysis system 102, immediately upon the detection of a particular event (e.g., a job description or a CV is newly submitted or updated). For ease of reference and discussion, the following description describes the operations of the career server system 130, the skill analysis system 102, the text analysis engine 108, the feedback-based model 110, the aggregate score calculation engine 112, the impression analysis engine 114, the action recommendation engine 150, and the client 160, as being performed with respect to a particular job description and a particular CV. However, it will be understood that the same operations would be performed for other job description(s) and/or CV(s). In this specification the term “engine” is used broadly to refer to a software-based system, subsystem, or process that is programmed to perform one or more specific functions. Generally, an engine will be implemented as one or more software components, installed on one or more computers in one or more locations. In some cases, one or more computers will be dedicated to a particular engine; in other cases, multiple engines can be installed and running on the same computer or computers. In some implementations, an engine includes one or more processors that can be assigned exclusively to that engine, or shared with other engines.

After obtaining a job description from the career server system 130, the text analysis engine 108 can parse the job description to extract the job description skills required and/or preferred for the job opening and generate the corresponding job description rankings. In addition, after obtaining a CV from the career server system 130, the text analysis engine 108 can parse the CV to extract the candidate skills described in the CV and generate the corresponding candidate skill rankings.

With respect to the job description, the text analysis engine 108 can analyze text of the job description to determine a list of skills described in the job description and the skills' corresponding job description rankings (e.g., by using the feedback-based model 110). A skill's job description ranking indicates the employer's determined weight (from the free-form job description) on the skill they want in a candidate. The job description ranking can be in a standard ranking scale. For example, must-have (required) skill, preferred skill, desired skill, and no marking can correspond to the ranking of 4, 3, 2, and 1, respectively. Thus, text rules can be defined (e.g., in the feedback-based model 110) to identify the skills and apply them to the pre-determined ranking scale.

With respect to the CV, the text analysis engine 108 can analyze text of the CV to determine a list of candidate skills described in the CV and the corresponding candidate skill rankings (e.g., by using the feedback-based model 110). A candidate skill ranking indicates the candidate's experience level of the corresponding candidate skill. The candidate skill ranking can be in a standard ranking scale. For example, proficient, intermediate, beginner, and no marking can correspond to the ranking of 4, 3, 2, and 1, respectively. Thus, text rules can be defined (e.g., in the feedback-based model 110) to identify the candidate skills and apply them to the pre-determined ranking scale.

In some cases, a machine-learning model can be trained to determine the job description skills, the job description rankings, the candidate skills, and/or the candidate skill rankings (more details are described below).

Because the techniques described herein are not dependent on any predefined organization or labeling/categorizing, the techniques can be used to analyze any unstructured (or widely varying) text (in the form of different and distinct job description/resume formats and types). As an example, the techniques described herein do not limit the identifications of skills in one or more predefined sections (e.g., skill section, qualification section, etc.) of the job descriptions/CVs, but can parse most or all of the job descriptions/CVs by, for example, searching keywords and analyzing their contexts to determine the skills and their corresponding rankings. Therefore, the techniques described herein do not require the job descriptions and/or CVs to include any predefined section. As another example, the techniques do not require the inputs to satisfy particular format requirements (e.g., a job description ranking has to be next to a job description skill) in order to be analyzed, and thus can be used for text of any formats and types.

After determining the job description rankings and the candidate skill rankings, the text analysis engine 108 can compute distances between the job description rankings and the candidate skill rankings (e.g., using the feedback-based model 110 and the text of both). For each job description skill extracted from the job description, the text analysis engine 108 can determine whether a corresponding candidate skill is extracted from the CV. If no corresponding candidate skill is found, the distance associated with the job description skill can be a predetermined maximum value (e.g., 4). If a corresponding candidate skill is found and the candidate skill ranking of the candidate skill is higher than or equal to the job description ranking of the job description skill, the distance between the job description skill and the candidate skill can be set to a predetermined minimum value (e.g., 0). If a corresponding candidate skill is found and the candidate skill ranking of the candidate skill is lower than the ranking of the job description skill, the distance between the job description skill and the candidate skill can be equal to the difference between the job description ranking of the job description skill and the candidate skill ranking of the candidate skill.

In some instances, the feedback-based model 110 can be a machine-learning model that can be used to compute distances between the job description rankings and the candidate skill rankings. The machine-learning model can be trained using a plurality of samples. Each sample can include a job description and its corresponding CV (e.g., a CV submitted to a job opening associated with the job description). The sample's label can include, for example, a list of job description skills extracted from the job description, a list of candidate skills extracted from the CV, and a set of distances between the job description skills and the candidate skills. When trained in this manner, the machine-learning model can identify matching skills and determine the distance between the skills.

In some cases, the text analysis engine 108 can transmit the computed distances between the job description rankings and the candidate skill rankings to the aggregate score calculation engine 112, which can then generate an aggregate score for each candidate based on the computed distances. In some examples, the aggregate score calculation engine 112 can sum up the computed distances of a candidate to generate an aggregate score for the candidate. For example, assuming that the computed distances of a candidate are 3, 1, 1, and 2, the aggregate score for the candidate would then be 7.

In general, the aggregate score is directly correlated with the candidate's fitness to the job opening. So, for example, a high aggregate score indicates a large disparity between the candidate's stated skills and the skills to perform the job, whereas a low aggregate score indicates a high likelihood that the candidate's skills satisfy the job requirements.

In some cases, the aggregate score calculation engine 112 can transmit the generated aggregate score(s) to the action recommendation engine 150, which can then recommend one or more actions for a candidate based on the candidate's aggregate score and/or the computed distances of the candidate. In some cases, the action recommendation engine 150 can use the aggregate score(s) to support pre-interview candidate selection. In one example, the action recommendation engine 150 can use the aggregate score(s) to screen job applicants. So, for example, the action recommendation engine 150 can recommend to grant an interview to a job applicant having an aggregate score that satisfies a predetermined threshold (e.g., lower than a predetermined threshold). In another example, the action recommendation engine 150 can use the aggregate score(s) to determine the interview time allocated to a candidate. For example, if the aggregate score indicates that the candidate may be a good fit for the job, the action recommendation engine 150 can allocate a longer interview time to thoroughly validate the candidate's skills.

In some instances, the action recommendation engine 150 can use the aggregate score(s) to support post-interview candidate selection, such as making a hiring recommendation. In one example, the action recommendation engine 150 can recommend to make an offer to a job applicant having an aggregate score that satisfies a predetermined threshold (e.g., lower than a predetermined threshold).

In some instances, the action recommendation engine 150 can use the computed distances for a candidate to generate and prioritize a list of questions to ask the candidate in the interview. For example, a large distance can indicate that the candidate may be incompetent in the corresponding skill and/or the skill is critical to the job, so the action recommendation engine 150 can recommend to prioritize questions for this skill over other questions.

As illustrated, the action recommendation engine 150 can transmit the action recommendation(s) to the client 160, which can then display the action recommendation(s). In some examples, the client 160 can generate, based on the computed distances, a checklist including a candidate's candidate skills and their distances to the job description skills. During the interview of the candidate, an interviewer can make real-time adjustments, for example, to the candidate's candidate skill rankings and/or their corresponding distances to the job description rankings, based on the candidate's performance in the interview. This allows more accurate assessment of the candidate.

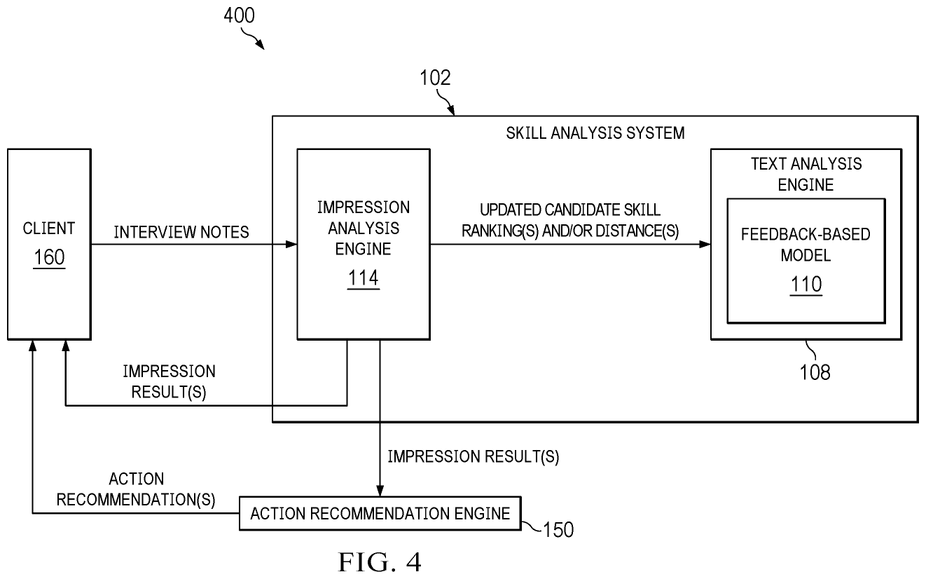

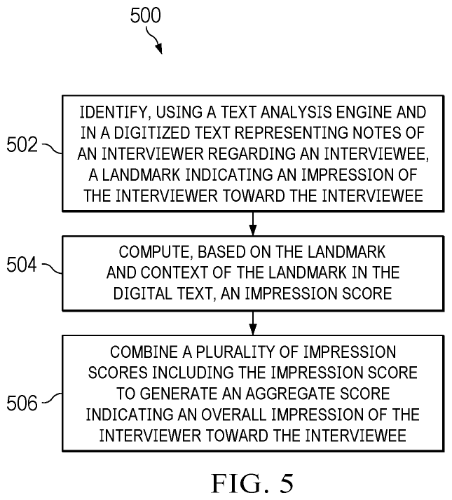

In addition to the interviewer's real-time adjustments, in some cases, the candidate's candidate skill rankings and/or their corresponding distances to the job description rankings can be automatically updated based on analyzing the interviewer's interview notes. In some cases, the impression analysis engine 114 can obtain digitized text representing the interview notes, analyze the digitized text to generate one or more impression results corresponding to a candidate skill, and then update, based on the one or more impression results, a candidate skill ranking and/or a distance corresponding to the candidate skill, for example, by using the example methods as described in FIGS. 4-5.

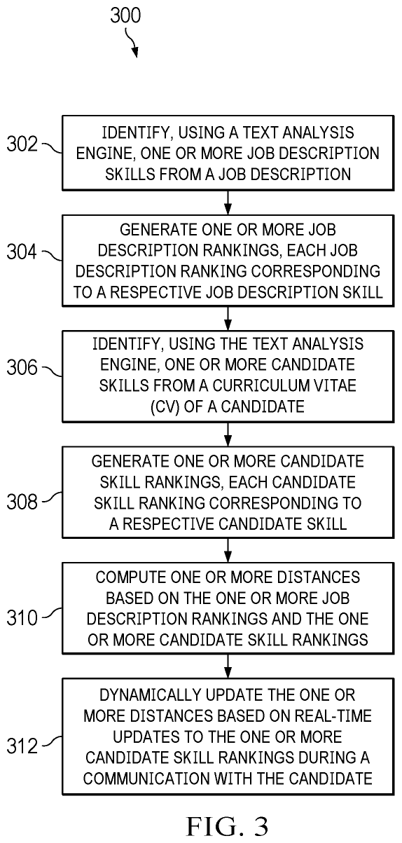

In some cases, after a candidate skill ranking and/or a distance corresponding to the candidate skill is updated, the updated candidate skill ranking and/or distance can be provided as input/feedback to the feedback-based model 110, which generated the candidate skill ranking and/or the distance, to further refine the model and improve its inference capabilities based on the human/machine annotated sample in the form of actual skill rankings. For example, the text rules in the feedback-based model 110 can be refined based on the updated candidate skill ranking and/or distance (more details are described in FIG. 3). For another example, when the feedback-based model 110 is a machine-learning model, the updated candidate skill ranking and/or distance can be a new sample that can be used to train and refine the feedback-based model 110.

In some examples, the impression analysis engine 114 and/or the text analysis engine 108 (which received the updated candidate skill ranking(s) from the impression analysis engine 114 and computed the updated distance) can provide the updated distance to the aggregate score calculation engine 112. The aggregate score calculation engine 112 can use the updated distance to compute an updated aggregate score (using similar operations as described above) and transmit the updated aggregate score to the action recommendation engine 150 which can then update the action recommendation(s), such as adjusting a hiring recommendation.

It should be noted that FIG. 2 only provides an example of the flows and interactions between an example set of components performing the operations described herein. Additional, alternative, or different combinations of components, interactions, and operations can be used in different implementations.

FIG. 3 is a flow diagram of an example method 300 for automating identifications of disparities between job requirements and candidate's stated skills. As explained further below, this flow diagram describes computing distances between rankings of the job description skills and rankings of the candidate skills based on automatic text analysis, and subsequently validating or updating the candidate skill ranking(s) and/or distance(s) based on the candidate's performance in the interview. It should be understood that method 300 can be performed, for example, by any suitable system, environment, software, and hardware, or a combination of systems, environments, software, and hardware as appropriate. In some instances, method 300 can be performed by a system including one or more components of the environment 100, including, among others, the skill analysis system 102 and the action recommendation engine 150, or portions thereof, described in FIG. 1, as well as other components or functionality described in other portions of this description. In other instances, the method 300 can be performed by a plurality of connected components or systems, such as those illustrated in FIG. 2. Any suitable system(s), architecture(s), or application(s) can be used to perform the illustrated operations.

In one instance, method 300 describes a method performed for one or more job descriptions and one or more CVs at a predetermined interval (e.g., every 30 days, every 7 days, etc.). In other instances, the method can be performed upon the occurrence of a particular event (e.g., a job description or a CV is newly submitted or updated). In some instances, a job description of a job opening and a CV of a job applicant who applies to the job opening can be obtained. The job description can describe, for example, the responsibilities, activities, qualifications, and skills for the job opening. The CV can include, for example, contact information, academic history, professional experience, qualifications and skills, awards and honors, publications, etc.

At 302, one or more job description skills can be identified, using a text analysis engine, from a job description. The job description can be parsed to extract the skills required and/or preferred for the job opening. A text analysis engine (e.g., the text analysis engine 108) can be employed to analyze text of the job description to determine a list of skills described in the job description. In some instances, the text analysis engine can first identify in the job description one or more sections that describe the skills, for example, by analyzing the titles/subjects of the one or more sections. In some cases, the titles/subjects can be separated by text or data formatting techniques, such as bullet points, so that the formatting specifier (e.g., bullet point) can be identified first and the text following the bullet point can then be determined as the title/subject. Further, identifying such titles/subjects can include, for example, searching for a title/subject that includes one or more keywords such as “expertise,” “skill,” “qualification,” “requirements,” etc. After identifying the skill section(s), the text analysis engine can further identify the skills listed in these skill section(s). In some instances, a dictionary can be constructed to store the skill keywords. The text analysis engine can then search in the job description to identify any skill that matches one or more skill keywords in the dictionary.

At 304, one or more job description rankings can be generated, each job description ranking corresponding to a respective job description skill. A job description ranking indicates the employer's determined weight (from the free-form job description) on the skill they want in a candidate. The job description ranking can be in a standard ranking scale. For example, must-have (required) skill, preferred skill, desired skill, and no marking can correspond to the ranking of 4, 3, 2, and 1, respectively. Thus, text rules can be defined (e.g., in a feedback-based model) to identify the job description skills and apply them to the pre-determined ranking scale.

In some instances, a dictionary (can be the same or different dictionary as described above) can be constructed to store keywords corresponding to the job description rankings. In the dictionary, each ranking can correspond to one or more keywords. When the text analysis engine detects a job description skill in the job description, the text analysis engine can analyze the context (e.g., nearby words of the job description skill) to search for keywords corresponding to any ranking. If one or more keywords of a particular ranking are detected in the context of a job description skill, the job description skill can be determined to have the job description ranking corresponding to the one or more keywords. For example, ranking of 4 can correspond to keywords such as “must-have,” “required,” etc. Ranking of 3 can correspond to keywords such as “preferred,” “strongly desired,” etc. Ranking of 2 can correspond to keywords such as “desired,” “preferred but not required,” etc. If a job description skill is detected and no corresponding keyword is detected, the job description skill can be assigned a ranking of 1.

In some instances, a machine-learning model (e.g., the feedback-based model 110) can be used to identify job description skills and/or their corresponding job description rankings. The machine-learning model can be trained using a plurality of samples. Each sample can include a job description. The sample's label can include, for example, one or more job description skills extracted from the job description and one or more job description rankings corresponding to the one or more job description skills. The job description to be analyzed can then be input into the trained machine-learning model to identify job description skills and/or their corresponding job description rankings.

At 306, one or more candidate skills from a CV of a candidate can be identified using the text analysis engine. Similar operations described above with respect to identifying job description skills in a job description can be used to identify the one or more candidate skills from a CV of a candidate, and are omitted here for brevity.

At 308, one or more candidate skill rankings can be generated, each candidate skill ranking corresponding to a respective candidate skill. A candidate skill ranking indicates the candidate's experience level of the corresponding candidate skill. The candidate skill ranking can be in a standard ranking scale. For example, proficient, intermediate, beginner, and no marking can correspond to the ranking of 4, 3, 2, and 1, respectively. Thus, text rules can be defined (e.g., in a feedback-based model) to identify the candidate skills and apply them to the pre-determined ranking scale.

Similar to generating the job description rankings, in some instances, a dictionary (can be the same or different dictionary as described above) can be constructed to store keywords corresponding to the candidate skill rankings. In the dictionary, each candidate skill ranking can correspond to one or more keywords. When the text analysis engine detects a candidate skill in the CV, the text analysis engine can analyze the context (e.g., nearby words of the candidate skill) to search for keywords corresponding to any ranking. If one or more keywords of a particular ranking are detected in the context of a candidate skill, the candidate skill can be determined to have the ranking corresponding to the one or more keywords. For example, ranking of 4 can correspond to keywords such as “proficient,” “well-versed,” etc. Ranking of 3 can correspond to keywords such as “intermediate,” “mid-level,” etc. Ranking of 2 can correspond to keywords such as “beginner,” “amateur,” etc. If a candidate skill is detected and no corresponding keyword is detected, the candidate skill can be assigned a ranking of 1.

In some instances, a machine-learning model (e.g., the feedback-based model 110) can be used to identify candidate skills and/or their corresponding candidate skill rankings. The machine-learning model can be trained using a plurality of samples. Each sample can include a CV. The sample's label can include, for example, one or more candidate skills extracted from the CV and one or more candidate skill rankings corresponding to the one or more candidate skills. The CV to be analyzed can then be input into the trained machine-learning model to identify candidate skills and/or their corresponding candidate skill rankings.

In some instances, a candidate skill ranking can be determined based on a number of times the candidate skill is mentioned in the CV. A plurality of quantity intervals can be predetermined for identifying the candidate skill rankings. If the number of times the candidate skill is mentioned in the CV falls in a particular quantity interval, the candidate skill ranking corresponding to the particular quantity interval can be assigned to the candidate skill. For example, the candidate skill rankings of 4, 3, 2, and 1 can correspond to “mentioned at least three times,” “mentioned at least two times,” “mentioned at least once,” and “not mentioned,” respectively. If the number of times the candidate skill is mentioned in the CV is two, the candidate skill can be assigned the ranking of 3.

In some instances, a candidate skill ranking can be determined based on a number of the candidate's jobs in which the candidate skill is described. A plurality of quantity intervals can be predetermined for identifying the candidate skill rankings. If the number of the candidate's jobs in which the candidate skill is described falls in a particular quantity interval, the candidate skill ranking corresponding to the particular quantity interval can be assigned to the candidate skill. For example, the candidate skill rankings of 4, 3, 2, and 1 can correspond to “at least three jobs,” “at least two jobs,” “at least one job,” and “no job,” respectively. If the number of times the candidate's jobs in which the candidate skill is described is two, the candidate skill can be assigned the ranking of 3.

In some instances, a candidate skill ranking can be determined based on whether a candidate skill is marked in any special formats such as bold, underlined, etc. For example, if the candidate skill is underlined in the CV, the candidate skill can be assigned the ranking of 4.

At 310, one or more distances can be computed based on the one or more job description rankings and the one or more candidate skill rankings. In some cases, a feedback-based model (e.g., the feedback-based model 110) can be employed to compute the one or more distances. For each job description skill extracted from the job description, whether a corresponding candidate skill is extracted from the CV can be determined. If no corresponding candidate skill is found, the distance associated with the job description skill can be a predetermined maximum value (e.g., 4). If a corresponding candidate skill is found and the candidate skill ranking of the candidate skill is higher than or equal to the job description ranking of the job description skill, the distance between the job description skill and the candidate skill can be a predetermined minimum value (e.g., 0). If a corresponding candidate skill is found and the candidate skill ranking of the candidate skill is lower than the ranking of the job description skill, the distance between the job description skill and the candidate skill can be equal to the difference between the job description ranking of the job description skill and the candidate skill ranking of the candidate skill.

Matching the job description skills and the candidate skills can be implemented via text matching algorithm in different manners. In some cases, textual matching (including exact matching) can be used to match the job description skills and the candidate skills (e.g., comparing and matching text/character strings for the job description skills and the candidate skills). For example, a job description/candidate skill of “JAVA” can be matched with a candidate/job description skill of “Java.” In other words, the text matching can be configured to be performed on the text itself, without regard to formatting of the text (e.g., upper case v. lower case).

In some examples, the matching algorithm does not require that the candidate skill contains exactly the same word(s) as the job description skill. In one implementation, mapping relationships (e.g., a database, a data table, a graph database, etc.) can be generated and specified between candidate skills and corresponding job description skills. For example, a job description skill of “programming” can be mapped to candidate skills of “C,” “C++,” “Python,” “Java,” etc. So, if a job description skill is “programming” and the CV lists at least one of “C,” “C++,” “Python,” or “Java,” it can be determined that the candidate has a candidate skill corresponding to the job description skill.

In some instances, the matching algorithm can include instructions for determining whether the job description skill/candidate skill is a subset of the candidate skill/job description skill. In some cases, the job description skill can be a subset of the candidate skill. In other words, the job description skill can describe a more specific skill than the candidate skill. For example, the job description skill can be “Java,” whereas the candidate skill can be more generic or vague, such as “Object Oriented programming” or simply computer programming. In such case, the candidate's distance for the “Java” skill can be penalized (e.g., by increasing the candidate's distance for the “Java” skill). Alternatively, a note can be generated next to the computed distance of the “Java” skill (e.g., an explanation of why the distance is penalized, a reminder for the interviewer to ask Java-related questions in the interview, etc.). On the other hand, the candidate skill can be a subset of the job description skill. For example, the job description skill can be “programming skills” and the candidate skill can be “Java.” In such case, the candidate skill is more specific than that required by the job description skill. In such case, the candidate's distance for the “programming skills” can be decreased. Alternatively, a note can be generated next to the computed distance of the “programming skills” (e.g., an explanation of why the distance is decreased, a reminder for the interviewer to ask whether the interviewee understands other programming languages than Java, etc.). In some cases, rule sets and/or machine-learning algorithms can be trained to determine the genus-species relationships for different skills. The varied distances can be used to refine the rule sets and/or machine-learning algorithms. For example, an increased distance can indicate that the job description skill is a subset of the candidate skill, whereas a decreased distance can indicate that the candidate skill is a subset of the job description skill.

In some cases, a machine-learning model can be used to infer the mapping relationships between candidate skills and corresponding job description skills. The machine-learning model can be trained using a plurality of samples. Each sample can include a job description skill and a candidate skill. The sample's label can be, for example, a value (e.g., 0 or 1) indicating whether the job description skill matches the candidate skill. Alternatively, each sample can include a job description and its corresponding CV (e.g., a CV submitted to a job opening associated with the job description). The sample's label can include, for example, a list of job description skills extracted from the job description and a list of candidate skills extracted from the CV, each of the candidate skill matches one or more of the list of job description skills. When trained in this manner, the machine-learning model can identify matching job description skill and candidate skills (thus providing a more dynamic mapping capabilities than what is afforded by rules-based frameworks).

In some instances, the feedback-based model can also be a machine-learning model (can be the same or different machine model as described above) that can be used to compute distances between the job description rankings and the candidate skill rankings. The machine-learning model can be trained using a plurality of samples. Each sample can include a job description and its corresponding CV (e.g., a CV submitted to a job opening associated with the job description). The sample's label can include, for example, a list of job description skills extracted from the job description, a list of candidate skills extracted from the CV, and a set of distances between the job description skills and the candidate skills. When trained in this manner, the machine-learning model can identify matching skills and determine the distance between the skills.

In some examples, an aggregate score can be generated based on the one or more distances. In some examples, the one or more distances can be summed up to generate an aggregate score for the candidate. In general, the aggregate score is directly correlated with the candidate's fitness to the job opening. So, for example, a high aggregate score indicates a large disparity between the candidate's stated skills and the skills to perform the job, whereas a low aggregate score indicates a high likelihood that the candidate's skills satisfy the job requirements.

In some cases, the aggregate scores can be used to recommend one or more actions for candidates. In some cases, the aggregate scores can be used to support pre-interview candidate selection. In one example, the aggregate scores can be used to screen job applicants. So, for example, an interview can be recommended to a job applicant having an aggregate score that satisfies a predetermined threshold (e.g., lower than a predetermined threshold). In another example, the aggregate score can be used to determine the interview time allocated to a candidate. For example, if the aggregate score indicates that the candidate may be a good fit for the job, a longer interview time can be allocated to thoroughly validate the candidate's skills.

In some instances, the aggregate scores can be used to support post-interview candidate selection, such as making hiring recommendations. In one example, an offer can be recommended for a job applicant having an aggregate score that satisfies a predetermined threshold (e.g., lower than a predetermined threshold).

In some instances, the computed distances can be used to generate and prioritize a list of questions to ask the candidate in the interview. For example, a large distance can indicate that the candidate may be incompetent in the corresponding skill and/or the skill is critical to the job, so questions for this skill can be recommended to be prioritized over other questions.

At 312, the one or more distances can be dynamically updated based on real-time updates to the one or more candidate skill rankings during a communication with the candidate. In some examples, a checklist including a candidate's candidate skills and their distances to the job description skills can be generated. During the interview of the candidate, an interviewer can make real-time adjustments, for example, to the candidate's candidate skill ranking(s) and/or their corresponding distance(s) to the job description ranking(s), based on the candidate's performance in the interview. This allows more accurate assessment of the candidate.

In addition to the interviewer's real-time adjustments, in some cases, the candidate's candidate skill ranking(s) and/or their corresponding distance(s) to the job description ranking(s) can be automatically updated based on analyzing the interviewer's interview notes. In some cases, digitized text representing the interview notes can be obtained. The digitized text can then be analyzed to generate one or more impression results corresponding to a candidate skill. Based on the one or more impression results, a candidate skill ranking and/or a distance corresponding to the candidate skill can be updated, for example, by using the example methods as described in FIGS. 4-5.

In some cases, after a candidate skill ranking and/or a distance corresponding to the candidate skill is updated, the updated candidate skill ranking and/or distance can be provided as input/feedback to the feedback-based model, which generated the candidate skill ranking and/or the distance, to further refine the model and improve its inference capabilities based on the human/machine annotated sample in the form of actual skill rankings.

In some cases, the text rules in the feedback-based model can be refined based on the updated candidate skill ranking(s) and/or distance(s). For example, assume that, prior to refining the text rules, the original text rule specified that the keyword “proficient” corresponded to a ranking of 3. If the candidate skill ranking is updated to 4 based on the candidate's performance in the interview, the original text rule can be updated to specify that the keyword “proficient” corresponds to a ranking of 4.

For another example, when the feedback-based model is a machine-learning model, the updated candidate skill ranking(s) and/or distance(s) can be a new sample that can be used to train and refine the feedback-based model. In such case, the new sample can include the CV and the label can be the updated candidate skill ranking(s) and/or distance(s). The new sample, either alone or in combination with other sample(s), can be used to train and refine the feedback-based model.

In some examples, after distance(s) has been updated during or after the interview, the updated distance(s) can be used to compute an updated aggregate score (using similar operations as described above). The updated aggregate score can then be used to update the action recommendation(s), such as adjusting a hiring recommendation.

FIG. 4 illustrates a data and control flow of example interactions 400 performed for automating candidate impression extraction based on interview notes analysis. As explained further below, this flow diagram describes automatically analyzing interview notes, factoring the landmarks included in the notes in the computation, and generating one or more results representing impressions toward the candidate (e.g., an overall impression score toward the candidate, the subjects contributing to the landmarks, etc.). As illustrated, FIG. 4 shows interactions between the client 160, the skill analysis system 102, the impression analysis engine 114, the text analysis engine 108, the feedback-based model 110, and the action recommendation engine 150.

In some cases, the client 160 can store interview notes regarding an interview with the interviewee. The interview notes can be in digital text (e.g., typed directly into the client 160), handwritten text, oral notes, etc. If the interview notes are not digital text, a computing device, such as the client 160 and/or the impression analysis engine 114, can digitize the interview notes by, for example, performing text recognition on handwritten text or performing audio recognition to generate a transcript for an audio.

As illustrated in FIG. 4, the client 160 can transmit the digitized text representing the interview notes to the impression analysis engine 114. In some implementations, the impression analysis engine 114 can identify a landmark in the digitized text. A landmark can be one or more words that are capitalized, bolded, and/or underlined, such as the “GREAT” in “what a GREAT answer” and the underlined “not” in “this is not good :(” A landmark can also be one or more emoticons, such as the “ [symbol] ” in “did market research but no experience in competitive analysis [symbol] ” and the “:(” in “this is not good :(” In addition, the landmark can be one or more punctuation marks (e.g. “?” “!” “ . . . ”), such as the “?!” in “didn't understand his/her answer?!” In other words, a landmark can be any characteristic present in text that indicates the interviewer's sentiment or feeling to the subject matter being described.

In some cases, the impression analysis engine 114 can generate one or more impression results for the landmark. The impression result(s) can indicate one or more impressions of the interviewer toward a candidate. In some cases, the one or more impressions results can be one or more impression scores and/or an aggregate impression score of the one or more impression scores. In some instances, numerical scores can be used to represent the impressions. For example, the impressions of happy, inspiring, sad, and angry can have the impression scores of 4, 3, −3, and −4, respectively. The individual impression scores for a candidate can be combined (e.g., summed up) to generate an aggregate impression score. For example, assume that four impressions are identified in an interview note, namely happy, inspiring, sad, and angry. The aggregate impression score can then be 4+3−3−4=0. Therefore, the aggregate impression score can indicate an overall impression toward a candidate. In the example described above, a higher aggregate impression score generally indicates a more positive impression toward the candidate. In some instances, candidates can be ranked based on their aggregate scores. The ranking of the candidates can then be used to as a reference for hiring decisions.

In some cases, the one or more impression results can be, for example, the subjects (e.g., skills, experience points) to which a landmark relates. For example, in the text of “did market research but no experience in competitive analysis [symbol] ,” both “market research” and “competitive analysis” can be potentially related subject of the unhappy impression. The two subjects (i.e., “market research” and “competitive analysis”) can be impression results representing factors contributing to the unhappy impression. This can, for example, help a reviewer of the interview note to quickly identify the subjects related to the impressions.

As illustrated, the impression analysis engine 114 can transmit the impression result(s) to the client 160. In some instances, the client 160 can highlight the identified landmark(s) and/or its context in the digitized text. The landmark(s) and/or its context can be highlighted to focus the user's attention to the most important parts for impression recollections. The highlighting can include, for example, changing text highlight color, changing font color, changing fonts, etc. For example, in the text of “did market research but no experience in competitive analysis [symbol] ,” the emoticon “ [symbol] ” can be highlighted. In this regard, the subject matter described herein can implement dynamic user interface adjustments that highlight the various sentiments detected in notes that in turn inform the overall impressions toward the candidate.

In some cases, the client 160 can detect a selection of the landmark (e.g., by mouse-hovering or selecting the landmark) in the digitized text. In response to detecting a selection of the landmark, the client 160 can display at least one of the impression score or the subject associated with the landmark in the digitized text.

In addition, the impression analysis engine 114 can transmit the impression result(s) to the action recommendation engine 150, which can recommend one or more actions for a candidate based on the candidate's impression result(s). In some instances, the action recommendation engine 150 can rank a plurality of interviewees based on a plurality of aggregate impression scores corresponding to the plurality of interviewees. The action recommendation engine 150 can then recommend one or more action based on the ranking, such as making an offer to a candidate, if the candidate is ranked among a predetermined number of top candidates based on the aggregate impression scores. The action recommendation engine 150 can transmit the action recommendation(s) to the client 160, which can then display the action recommendation(s).

In some instances, the impression analysis engine 114 can update a candidate skill ranking and/or a distance corresponding to the candidate skill based on the one or more impression results. In some cases, an impression result can change the candidate skill ranking and/or distance initially generated by analyzing the job description and the candidate's CV. For example, by analyzing the job description and the candidate's CV, an initial candidate skill ranking of 1 (i.e., no marking) can be generated for a candidate skill of a candidate. However, the interviewer can validate the interviewee's candidate skill during the interview. By analyzing the interviewer's notes, a happy impression about the candidate skill can be detected (e.g., an impression score of 4 for the subject of the candidate skill). Accordingly, the candidate skill ranking can be updated from 1 to a higher ranking, such as 3 or 4. The distance to the job description ranking can then be reduced accordingly based on the example methods described above.

In some examples, the impression analysis engine 114 can provide the updated candidate skill ranking(s) and/or distance(s) as input/feedback to the feedback-based model 110, which generated the initial candidate skill ranking and/or distance, to further refine the model and improve its inference capabilities based on the human/machine annotated sample in the form of actual skill rankings (e.g., by using the example methods described in FIGS. 2-3).

It should be noted that FIG. 4 provides an example of the flows and interactions between an example set of components performing the operations described herein. Additional, alternative, or different combinations of components, interactions, and operations can be used in different implementations.

FIG. 5 is a flow diagram of an example method 500 for automating candidate impression extraction based on interview notes analysis. As explained further below, this flow diagram describes automatically analyzing interview notes, factoring the landmarks included in the notes in the computation, and generating one or more results representing impressions toward the candidate (e.g., an overall impression score toward the candidate, the subjects contributing to the landmarks, etc.). It should be understood that method 500 can be performed, for example, by any suitable system, environment, software, and hardware, or a combination of systems, environments, software, and hardware as appropriate. In some instances, method 500 can be performed by a system including one or more components of the environment 100, including, among others, the impression analysis engine 114 and the action recommendation engine 150, or portions thereof, described in FIG. 1, as well as other components or functionality described in other portions of this description. In other instances, the method 500 can be performed by a plurality of connected components or systems, such as those illustrated in FIG. 4. Any suitable system(s), architecture(s), or application(s) can be used to perform the illustrated operations.

At 502, a landmark indicating an impression of the interviewer toward the interviewee can be identified using a text analysis engine (e.g., the impression analysis engine 114) and in a digitized text representing notes of an interviewer regarding an interviewee. In some cases, the interview notes can be in digital text (e.g., typed directly into a computing device), handwritten text, oral notes, etc. If the interview notes are not digital text, a computing device, such as the client 160 and/or the impression analysis engine 114, can digitize the interview notes by, for example, performing text recognition on handwritten text or performing audio recognition to generate a transcript for an audio.

In some implementations, the landmark can be one or more words that are capitalized, bolded, and/or underlined, such as the “GREAT” in “what a GREAT answer” and the underlined “not” in “this is not good :(” A landmark can also be one or more emoticons, such as the “ [symbol] ” in “did market research but no experience in competitive analysis [symbol] ” and the “:(” in “this is not good :(” In addition, the landmark can be one or more punctuation marks (e.g. “?” “!” “ . . . ”), such as the “?!” in “didn't understand his/her answer?!” In other words, a landmark can be any characteristic present in text that indicates the interviewer's sentiment or feeling to the subject matter being described.

In some instances, a dictionary can be constructed to store example landmarks. The text analysis engine can scan the digitized text to identify any landmark that matches example landmark in the dictionary. In some cases, the scanning can be performed from the beginning of the digitized text (forward scanning), from the end of the digitized text (backward scanning), or from both the beginning and the end of the digitized text (parallel scanning).

At 504, an impression score can be computed based on the landmark and context of the landmark in the digitized text. In some cases, the impression score can be a numerical score used to represent the impression. For example, the impressions of happy, inspiring, sad, and angry can have the impression scores of 4, 3, −3, and −4, respectively. In some instances, mapping relationship can be established between impressions and their corresponding numerical scores.

In some instances, the nearby words of a landmark (e.g., a quantity of words, sentences, paragraphs, etc., before or after the landmark) can be identified first. Sentiment analysis can be performed on the landmark and its context by using a deep language model (e.g., ROBERTa) to identify a sentiment. The numerical score corresponding to the sentiment can then be the impression score.

In some cases, a machine-learning model can be trained to generate the impression score. The landmark(s) and/or its context can be one or more features of a sample that is used to train the machine-learning model, and the label of the sample can be one or more impression scores. When trained in this manner, the machine-learning model can determine impression score(s) based on input including the landmark(s) and/or its context. The identified landmark(s) and/or its context in an interview note to be analyzed can then be input into the trained machine-learning model to determine an impression score. In some instances, an off-the-shelf emotion model can be modified to add weights to the landmarks for analyzing interview notes. In this manner, a preconfigured model can be further finetuned to operate on and provide inferences with respect to sentiments/landmarks typically identified in interview notes.

In some cases, sentiment analysis tools or algorithms can be deployed to identify the landmarks and generate the impression scores. However, in some cases, such sentiment analysis tools or algorithms can be further finetuned to identify additional types of landmarks in the digitized text (e.g., the sentiment analysis tool does not capture emoticons, underlines, etc.). In such implementations, for example, such a finetuned sentiment analysis tool/algorithm can generate an impression score associated with a “happy” impression by processing the digitized text and identifying a number of smileys/emoticons associated with the “happy” impression (e.g., the text string :-) or :), or the graphical emoticon corresponding to such text strings). Then, the impression score can be increased (e.g., by a predetermined amount (e.g., 0.5) or percent (10%) for each smiley emoticon). So, for example, assuming that the refined sentiment analysis tool/algorithm generates an impression score of 4 associated with a “happy” impression and that two smiley emoticons are associated with the “happy” impression, the final impression score associated with the “happy” impression can be calculated as 4+0.5+0.5=5 (in this example, the impression score is increased by 0.5 for each identified emoticon).

In addition to the impression score, in some cases, one or more other impression results for the landmark can be computed based on the landmark and context of the landmark in the digitized text. In some cases, the one or more other impression results can be, for example, the subjects (e.g., skills, experience points) to which a landmark relates. For example, in the text of “did market research but no experience in competitive analysis [symbol] ,” both “market research” and “competitive analysis” can be potentially related subject of the unhappy impression. The two subjects (i.e., “market research” and “competitive analysis”) can be impression results representing factors contributing to the unhappy impression. This can, for example, help a reviewer of the interview note to quickly identify the subjects related to the impressions.

In some examples, the subject associated with the landmark can be inferred based on the landmark and its context. For one example, named entity recognition can be performed to identify named entities described in the context of the landmark. The named entities can be the subject(s). For another example, topic modeling (e.g., Latent Dirichlet allocation (LDA)) can be performed to identify topic(s) described in the context of the landmark. The topic(s) can be the subject(s).

In some instances, the impression result(s) can include specific part(s) of the context which most contribute to the impression score and/or the subject. In some cases, explainable AI can be used to identify the specific part(s) of the context which most contribute to the impression score and/or the subject. For example, an impression score of 4 can be computed based on the emoticon “ [symbol] ”. Then, the text “this is good, I like that,” which is nearby the emoticon “ [symbol] ”, can be identified as an important indicator for the positive impression. The identified specific part(s) of the context can help a reviewer of the interview note to quickly identify support for the impression score and/or the subject.

In some instances, the identified landmark and/or its context can be highlighted in the digitized text. The landmark and/or its context can be highlighted to focus the user's attention to the most important parts for impression recollections. The highlighting can include, for example, changing text highlight color, changing font color, changing fonts, etc. For example, in the text of “did market research but no experience in competitive analysis [symbol] ,” the emoticon “ [symbol] ” can be highlighted. In this regard, the subject matter described herein can implement dynamic user interface adjustments that highlight the various sentiments detected in notes that in turn inform the overall impressions toward the candidate.

In some cases, the landmark and/or its context can be highlighted in a highlighting manner indicating a strength of the impression. In some examples, each strength of the impression can correspond to a respective highlighting color, font, shade, etc. For example, highlighting using both bold and underlined can correspond to a stronger impression than just bold or just underlined. In some cases, the strength of the impression can be determined based on the impression score. For example, for a positive impression, a greater impression score can correspond to a stronger impression than a lower impression score. Alternatively, for a negative impression, a lower impression score can correspond to a stronger impression than a greater impression score.

In some examples, a selection of the landmark (e.g., by mouse-hovering or selecting the landmark) can be detected in the digitized text. In response to detecting a selection of the landmark, at least one of the impression score or the subject associated with the landmark can be displayed in the digitized text.

At 506, a plurality of impression scores including the impression score can be combined to generate an aggregate impression score indicating an overall impression of the interviewer toward the interviewee. In some cases, the individual impression scores for a candidate can be combined (e.g., summed up) to generate an aggregate impression score. For example, assume that four impressions are identified in an interview note, namely happy, inspiring, sad, and angry. The aggregate impression score can then be 4+3−3−4=0. Therefore, the aggregate impression score can indicate an overall impression toward a candidate. In the example described above, a higher aggregate impression score generally indicates a more positive impression toward the candidate. In some instances, candidates can be ranked based on their aggregate scores. The ranking of the candidates can then be used to as a reference for hiring decisions.

In some instances, a plurality of interviewees can be ranked based on a plurality of aggregate impression scores corresponding to the plurality of interviewees. Based on the ranking, if the candidate is ranked among a predetermined number of top candidates based on the aggregate impression scores, one or more actions, such as making an offer to a candidate, can be recommended.

In some instances, a candidate skill ranking and/or a distance corresponding to the candidate skill can be updated based on the one or more impression results. In some cases, an impression result can change the candidate skill ranking and/or distance initially generated by analyzing the job description and the candidate's CV. For example, by analyzing the job description and the candidate's CV, an initial candidate skill ranking of 1 (i.e., no marking) can be generated for a candidate skill of a candidate. However, the interviewer can validate the interviewee's candidate skill during the interview. By analyzing the interviewer's notes, a happy impression about the candidate skill can be detected (e.g., an impression score of 4 for the subject of the candidate skill). Accordingly, the candidate skill ranking can be updated from 1 to a higher ranking, such as 3 or 4. The distance to the job description ranking can then be reduced accordingly based on the example methods described above.

In some examples, the updated candidate skill ranking(s) and/or distance(s) can be provided as input/feedback to the feedback-based model, which generated the initial candidate skill ranking and/or distance, to further refine the model and improve its inference capabilities based on the human/machine annotated sample in the form of actual skill rankings (e.g., by using the example methods described in FIGS. 2-3). Additionally, the data representing impression relating to the interviewee, where the data can include the aggregate impression score, can then be provided for display on a client device.

The above description is provided in the context of interview process and candidate ranking, in particular, identifications of disparities between job requirements and candidate's stated skills and candidate impression extraction based on interview notes analysis. These use cases can be applied to any organization that interviews candidates, including but not limited to companies, corporations, governments, non-governmental organizations, political organizations, international organizations, armed forces, charities, not-for-profit corporations, partnerships, cooperatives, and educational institutions, etc. One skilled in the art will appreciate that the techniques described herein are not limited to just these applications but can be applicable in other contexts.

For example, in some implementations, the techniques described herein for automatically extracting impressions of the creator of the digital text can be extended to other use cases for extracting impressions from any digital text that includes landmarks. Example of such use cases include but not limited to analyzing a customer's impressions toward a merchant based on chat history, analyzing a reviewer's impressions toward a reviewee based on the reviewer's report, extracting a person's impressions toward a subject from emails, etc.

In one example use case, the techniques described herein can be used to analyze the text generated by a customer on a product (e.g., reviews written by the customer on the product, chat history of the customer on the product, etc.) to evaluate the customer's impressions toward the product. In another example use case, an employer can use the techniques described herein for performance management evaluations for existing employees. For example, the review report(s) of a reviewer for an existing employee can be analyzed to generate impressions of the reviewer toward the existing employee.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
at least one memory storing instructions; and
at least one hardware processor interoperably coupled with the at least one memory, wherein execution of the instructions by the at least one hardware processor causes performance of operations comprising:
identifying, using a text analysis engine, one or more job description skills from a job description;
generating one or more job description rankings, each job description ranking corresponding to a respective job description skill;
identifying, using the text analysis engine, one or more candidate skills from a curriculum vitae (CV) of a candidate;
generating one or more candidate skill rankings, each candidate skill ranking corresponding to a respective candidate skill;
computing one or more distances based on the one or more job description rankings and the one or more candidate skill rankings; and
dynamically updating the one or more distances based on real-time updates to the one or more candidate skill rankings during a communication with the candidate.

2. The system of claim 1, wherein generating the one or more job description rankings comprises:
identifying one or more words comprised in the job description associated with description of a job description skill;
determining whether the one or more words correspond to a job description ranking; and
in response to determining that the one or more words correspond to a job description ranking, assigning the job description ranking to the job description skill.

3. The system of claim 1, wherein the one or more candidate skill rankings are generated based on at least one of:
a number of times a candidate skill is comprised in the CV;
a number of jobs in the CV comprising the candidate skill; or
a font used to encode a candidate skill in the CV.

4. The system of claim 1, wherein computing the one or more distances based on the one or more job description rankings and the one or more candidate skill rankings comprises:
in response to determining that none of the one or more candidate skills corresponds to a job description skill, setting a distance associated with the job description skill to a predetermined maximum value;
in response to determining that a candidate skill ranking of a candidate skill is higher than or equal to a job description ranking of a job description skill, setting a distance between the candidate skill and the job description skill to a predetermined minimum value; or
in response to determining that a candidate skill ranking of a candidate skill is lower than a job description ranking of a job description skill, setting a distance between the candidate skill and the job description skill to a difference between the job description ranking and the candidate skill ranking.

5. The system of claim 1, the operations comprising:
generating an aggregate score based on the one or more distances.

6. The system of claim 5, wherein the aggregate score is used to determine at least one of:
whether to perform the communication with the candidate;
a duration of the communication with the candidate; or
a hiring decision of the candidate.

7. The system of claim 1, wherein dynamically updating the one or more distances based on the real-time updates to the one or more candidate skill rankings during the communication with the candidate comprises:
generating digitized text representing notes of the communication with the candidate;
analyzing the digitized text to generate one or more impression results corresponding to a candidate skill; and
updating, based on the one or more impression results, a distance corresponding to the candidate skill.

8. A computer-implemented method, comprising:
identifying, using a text analysis engine, one or more job description skills from a job description;
generating one or more job description rankings, each job description ranking corresponding to a respective job description skill;
identifying, using the text analysis engine, one or more candidate skills from a curriculum vitae (CV) of a candidate;
generating one or more candidate skill rankings, each candidate skill ranking corresponding to a respective candidate skill;
computing one or more distances based on the one or more job description rankings and the one or more candidate skill rankings; and
dynamically updating the one or more distances based on real-time updates to the one or more candidate skill rankings during a communication with the candidate.

9. The computer-implemented method of claim 8, wherein generating the one or more job description rankings comprises:
identifying one or more words comprised in the job description associated with description of a job description skill;
determining whether the one or more words correspond to a job description ranking; and
in response to determining that the one or more words correspond to a job description ranking, assigning the job description ranking to the job description skill.

10. The computer-implemented method of claim 8, wherein the one or more candidate skill rankings are generated based on at least one of:
a number of times a candidate skill is included in the CV;
a number of jobs in the CV comprising the candidate skill; or
a font used to encode a candidate skill in the CV.

11. The computer-implemented method of claim 8, wherein computing the one or more distances based on the one or more job description rankings and the one or more candidate skill rankings comprises:
in response to determining that none of the one or more candidate skills corresponds to a job description skill, setting a distance associated with the job description skill to a predetermined maximum value;
in response to determining that a candidate skill ranking of a candidate skill is higher than or equal to a job description ranking of a job description skill, setting a distance between the candidate skill and the job description skill to a predetermined minimum value; or
in response to determining that a candidate skill ranking of a candidate skill is lower than a job description ranking of a job description skill, setting a distance between the candidate skill and the job description skill to a difference between the job description ranking and the candidate skill ranking.

12. The computer-implemented method of claim 8, comprising:
generating an aggregate score based on the one or more distances.

13. The computer-implemented method of claim 12, wherein the aggregate score is used to determine at least one of:
whether to perform the communication with the candidate;
a duration of the communication with the candidate; or
a hiring decision of the candidate.

14. The computer-implemented method of claim 8, wherein dynamically updating the one or more distances based on the real-time updates to the one or more candidate skill rankings during the communication with the candidate comprises:
generating digitized text representing notes of the communication with the candidate;
analyzing the digitized text to generate one or more impression results corresponding to a candidate skill; and
updating, based on the one or more impression results, a distance corresponding to the candidate skill.

15. A non-transitory, computer-readable medium storing computer-readable instructions, that upon execution by at least one hardware processor, cause performance of operations, comprising:
identifying, using a text analysis engine, one or more job description skills from a job description;
generating one or more job description rankings, each job description ranking corresponding to a respective job description skill;
identifying, using the text analysis engine, one or more candidate skills from a curriculum vitae (CV) of a candidate;
generating one or more candidate skill rankings, each candidate skill ranking corresponding to a respective candidate skill;
computing one or more distances based on the one or more job description rankings and the one or more candidate skill rankings; and
dynamically updating the one or more distances based on real-time updates to the one or more candidate skill rankings during a communication with the candidate.

16. The non-transitory, computer-readable medium of claim 15, wherein generating the one or more job description rankings comprises:
identifying one or more words comprised in the job description associated with description of a job description skill;
determining whether the one or more words correspond to a job description ranking; and
in response to determining that the one or more words correspond to a job description ranking, assigning the job description ranking to the job description skill.

17. The non-transitory, computer-readable medium of claim 15, wherein the one or more candidate skill rankings are generated based on at least one of:
a number of times a candidate skill is comprised in the CV;
a number of jobs in the CV comprising the candidate skill; or
a font used to encode a candidate skill in the CV.

18. The non-transitory, computer-readable medium of claim 15, wherein computing the one or more distances based on the one or more job description rankings and the one or more candidate skill rankings comprises:
in response to determining that none of the one or more candidate skills corresponds to a job description skill, setting a distance associated with the job description skill to a predetermined maximum value;
in response to determining that a candidate skill ranking of a candidate skill is higher than or equal to a job description ranking of a job description skill, setting a distance between the candidate skill and the job description skill to a predetermined minimum value; or
in response to determining that a candidate skill ranking of a candidate skill is lower than a job description ranking of a job description skill, setting a distance between the candidate skill and the job description skill to a difference between the job description ranking and the candidate skill ranking.

19. The non-transitory, computer-readable medium of claim 15, the operations comprising:
generating an aggregate score based on the one or more distances.

20. The non-transitory, computer-readable medium of claim 19, wherein the aggregate score is used to determine at least one of:
whether to perform the communication with the candidate;
a duration of the communication with the candidate; or
a hiring decision of the candidate.
